(19) United States
(12) Patent Application Publication
(10) Pub. No.: US 2025/0036955 A1
(43) Pub. Date: Jan. 30, 2025

(54) SYSTEM OF ASSISTING IN BUILDING MACHINE LEARNING MODEL WITHOUT PROGRAMMING AND METHOD THEREOF

(71) Applicant: MITAC INFORMATION TECHNOLOGY CORP., Taipei City (TW)

(72) Inventors: Hsi-Yu CHEN, Taipei City (TW); Wen-Shou CHIU, Taipei City (TW)

(21) Appl. No.: 18/227,012

(22) Filed: Jul. 27, 2023

(51) Int. Cl. G06N 3/091; G06F 40/134; G06F 40/205; G06N 20/00

(52) U.S. Cl. CPC G06N 3/091; G06F 40/134; G06F 40/205; G06N 20/00

(57) ABSTRACT

A system of assisting in building machine learning model without programming and a method thereof is disclosed. A machine learning model building host provides an interactive question-and-answer area corresponding to a step process being executed, through an operation interface; the machine learning model building host provides a query message to an artificial intelligence platform through the Interactive question-and-answer area of an application programming interface, and the artificial intelligence platform provides the query message to a large language model to generate an answer message, the artificial intelligence platform transmits the answer message to the machine learning model building host, through the application programming interface, so as to achieve the technical effect of assisting in building a machine learning model without programming.

### BACKGROUND

### 1. Technical Field

The present invention relates to a machine learning model building system and a method thereof. More particularly, the present invention provides a system of assisting in building a machine learning model without programming through a question and answer interface, and a method thereof.

### 2. Description of the Related Arts

Machine learning is a type of artificial intelligence that focuses on building systems that can learn or improve performance based on the data used. Artificial intelligence is a broad term that refers to systems and machines that can simulate human intelligence. Machine learning and artificial intelligence are often discussed together, these two terms are sometimes used interchangeably, but their meanings are not the same. One important distinction is that all machine learning technologies are AI technologies, not all AI technologies are machine learning technologies.

The conventional method of building a machine learning model is very dependent on the programming ability of the technicians, and it causes a lot of time cost in building the machine learning model. In order to save time in building the machine learning model, a machine learning model building system with a drag-and-drop GUI interface is developed; however, because of simplification of operation, the machine learning model building system with drag-and-drop GUI interface may cause the builders who are not familiar with operation of a machine learning model cannot understand how to build a machine learning model.

Therefore, what is needed is to develop an improved solution to solve the conventional problem that the conventional machine learning model building system with a drag-and-drop GUI interface lacks of assisting in building the machine learning model.

### SUMMARY

An objective of the present invention is to provide a system of assisting in building machine learning model without programming and a method thereof, to solve the problem of the conventional machine learning model building system with a drag-and-drop GUI interface lacks of assisting in building the machine learning model.

In order to achieve the objective, the present invention discloses a system of assisting in building machine learning model without programming, the system includes an artificial intelligence platform and a machine learning model building host, the machine learning model building host includes an operation interface, non-transitory computer readable storage medium, and a hardware processor.

The artificial intelligence platform is configured to receive a query message through an application programming interface, provide the query message to a large language model to generate an answer message, and transmit the answer message through the application programming interface.

The operation interface is configured to provide a machine learning model building operation area, the non-transitory computer readable storage medium is configured to store computer readable instructions, the hardware processor is electrically connected to the non-transitory computer readable storage medium and the operation interface, and configured to execute the computer readable instructions to make machine learning model building host perform the following processes: providing an operation and a description of each of step processes of building a machine learning model on the machine learning model building operation area; providing an interactive question-and-answer area corresponding to one of the step processes being executed, through an operation interface, wherein the Interactive question-and-answer area comprises a query input part and a question and answer display part; receiving the query message on the query input part, transmitting the query message through an application programming interface, and displaying the query message on the question and answer display part; receiving the answer message through the application programming interface, and displaying the answer message on the question and answer display part.

In order to achieve the objective, the present invention discloses a method of assisting in building machine learning model without programming, and the method includes steps of: connecting a machine learning model building host and an artificial intelligence platform; providing a machine learning model building operation area through an operation interface of the machine learning model building host; providing an operation and a description of one of step processes of building a machine learning model on the machine learning model building operation area, by the machine learning model building host; providing an interactive question-and-answer area corresponding to one of the step processes being executed through the operation interface, by the machine learning model building host, wherein the Interactive question-and-answer area comprises a query input part and a question and answer display part; receiving a query message through the query input part of the machine learning model building host, and displaying the query message on the interactive question-and-answer area; transmitting the query message to the artificial intelligence platform through an application programming interface of the machine learning model building host; providing the query message to a large language model to generate the answer message, by the artificial intelligence platform; transmitting the answer message to the machine learning model building host through the application programming interface, by the artificial intelligence platform; displaying the answer message on the question and answer display part, by the machine learning model building host.

According to the above-mentioned system and method of the present invention, the machine learning model building host provides the interactive question-and-answer area corresponding to the step process being executed through an operation interface; the machine learning model building host provides the query message to the artificial intelligence platform through the interactive question-and-answer area of the application programming interface, and the artificial intelligence platform provides the query message to the large language model to generate an answer message, the artificial intelligence platform transmits the answer message to the machine learning model building host through the application programming interface, so as to achieve the technical effect of assisting in building a machine learning model without programming.

### BRIEF DESCRIPTION OF THE DRAWINGS

The structure, operating principle and effects of the present invention will be described in detail by way of various embodiments which are illustrated in the accompanying drawings.

FIG. 1 is a block diagram of a system of assisting in building machine learning model without programming, according to the present invention.

FIG. 2A is a schematic view of an operation interface of a system of assisting in building machine learning model without programming, according to the present invention.

FIG. 2B is a schematic view of a first embodiment of an interactive question-and-answer area of a system of assisting in building machine learning model without programming, according to the present invention.

FIG. 2C is a schematic view of a second embodiment of an interactive question-and-answer area of a system of assisting in building machine learning model without programming, according to the present invention.

FIG. 2D is a schematic view of a query message of a system of assisting in building machine learning model without programming, according to the present invention.

FIG. 2E is a schematic view of an answer message of a system of assisting in building machine learning model without programming, according to the present invention.

FIG. 3A is a schematic view of a label suggestion of a system of assisting in building machine learning model without programming, according to the present invention.

FIG. 3B is a schematic view of a feature word of a system of assisting in building machine learning model without programming, according to the present invention.

FIGS. 4A and 4B are flowcharts of a method of assisting in building machine learning model without programming, according to the present invention.

### DETAILED DESCRIPTION

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

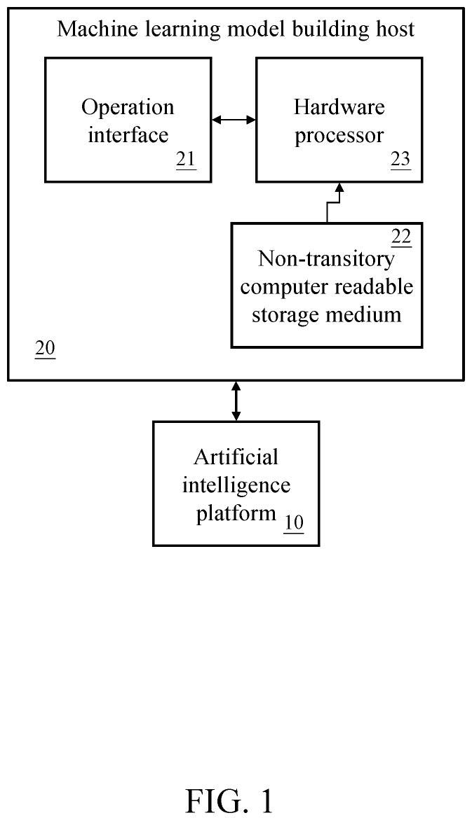

The system of assisting in building machine learning model without programming of the present invention will be illustrated in the following paragraphs. Please refer to FIG. 1, which is a block diagram of a system of assisting in building machine learning model without programming, according to the present invention.

As shown in FIG. 1, the system includes an artificial intelligence platform 10 and a machine learning model building host 20; the machine learning model building host 20 includes an operation interface 21, a non-transitory computer readable storage medium 22 and a hardware processor 23.

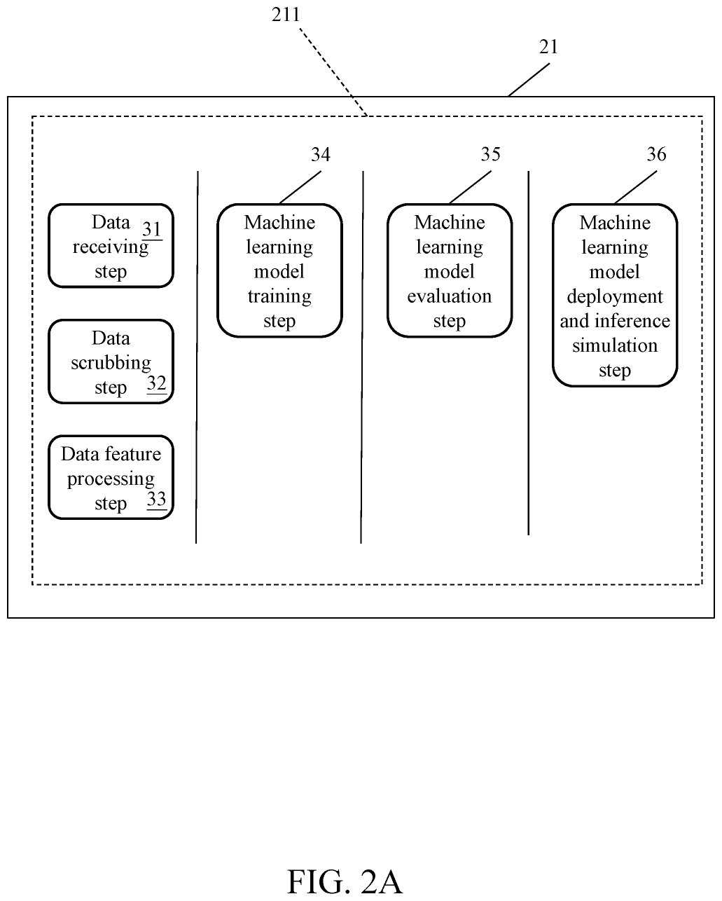

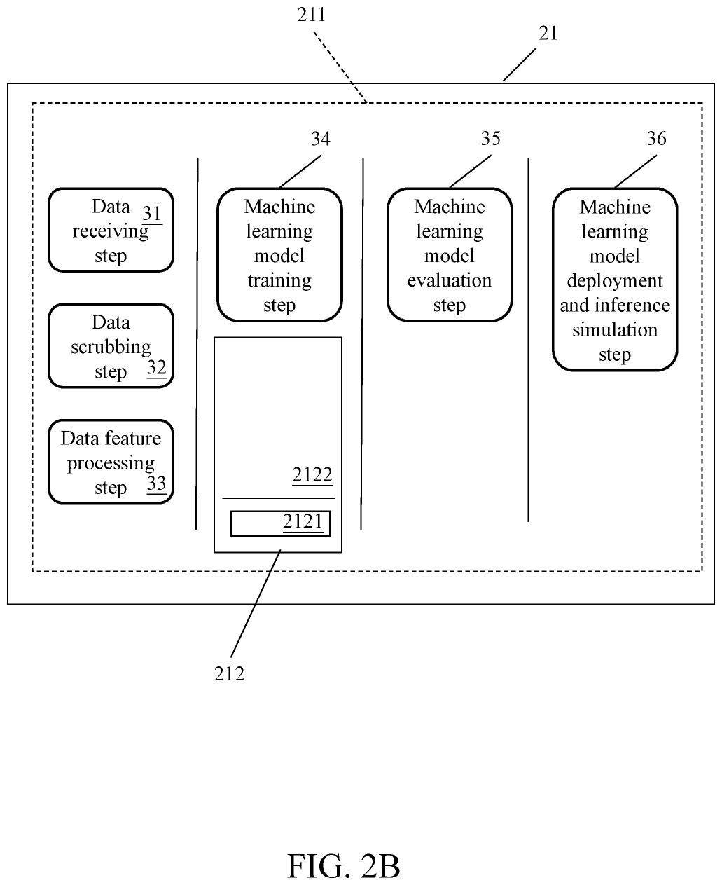

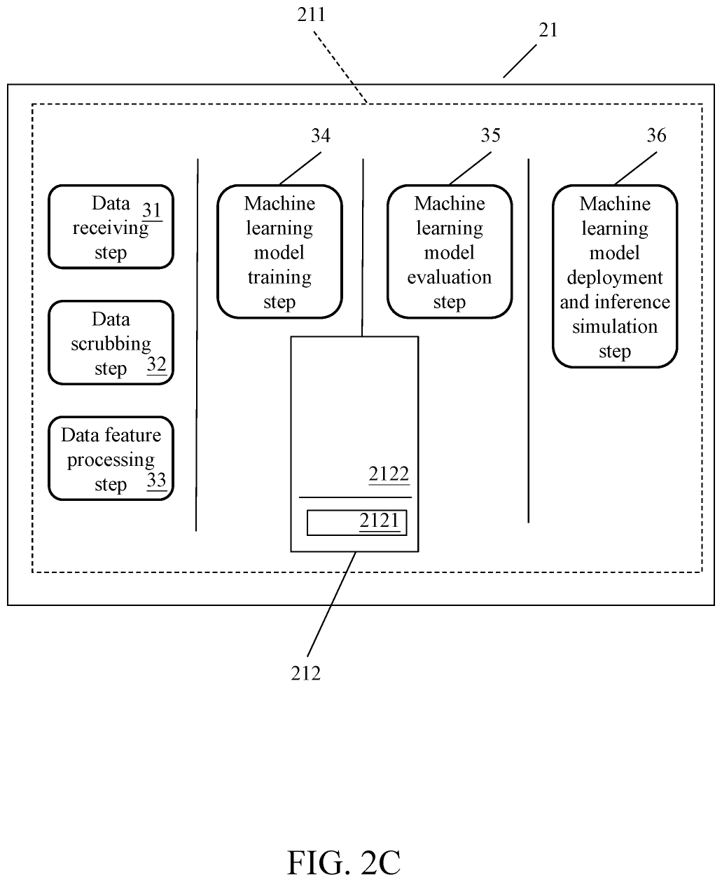

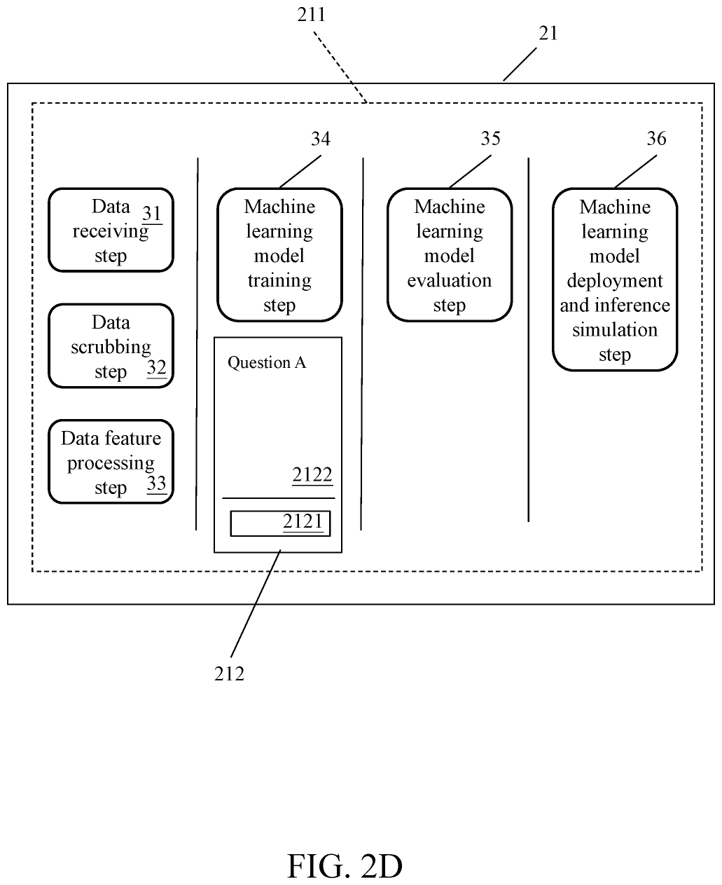

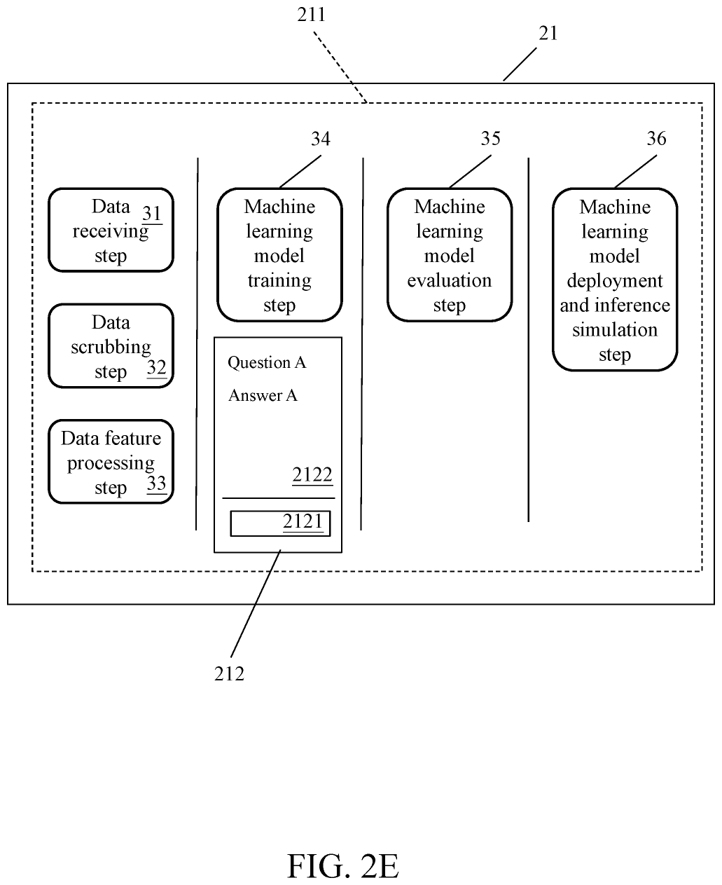

Please refer to FIG. 2A, which is a schematic view of an operation interface of system of assisting in building machine learning model without programming, according to the present invention.

The operation interface 21 is configured to provide a machine learning model building operation area 211, the machine learning model building operation area 211 is configured to provide an operation and description of each of step processes of building a machine learning model, the non-transitory computer readable storage medium 22 stores computer readable instructions, and the hardware processor 23 is electrically connected to a non-transitory computer readable storage medium 22 and an operation interface 21. In an embodiment, the non-transitory computer readable storage medium 22 can include a hard disk, an optical disk or a flash memory, but these examples are merely for exemplary illustration, and an application field of the present invention is not limited thereto. Furthermore, the computer readable instruction means instructions which can be interpreted and executed by the machine learning model building host 20 (such as a computer).

The hardware processor 23 executes the computer readable instructions, to make the machine learning model building host 20 performs the following processes.

When the hardware processor 23 executes the computer readable instructions, the machine learning model building host 20 provides an operation and a description of each of step processes of building the machine learning model on the machine learning model building operation area 211, as shown in FIG. 2A, the step processes of the machine learning model can include a data receiving step 31 and a data scrubbing step 32, a data feature processing step 33, a machine learning model training step 34, a machine learning model evaluation step 35, and a machine learning model deployment and inference simulation step 36; however, these examples are merely for exemplary illustration, and the application field of the present invention is not limited to these examples.

Please refer to FIG. 2B, which is a schematic view of a first embodiment of an interactive question-and-answer area of system of assisting in building machine learning model without programming, according to the present invention.

As shown in FIG. 2B, the data receiving step 31 is taken as example of the step process being executed by the machine learning model. The operation interface 21 embeds the Interactive question-and-answer area 212 in the machine learning model building operation area 211 and near the machine learning model training 34, and the Interactive question-and-answer area 212 includes a query input part 2121 and a question and answer display part 2122. It should be noted that the embedded Interactive question-and-answer area 212 can be presented at any appropriate location in the operation 211, or presented via a popup; however, these examples are merely for exemplary illustration, and the application field of the present invention is not limited to these examples.

Please refer to FIG. 2C, which is a schematic view of a second embodiment of an interactive question-and-answer area of system of assisting in building machine learning model without programming, according to the present invention.

As shown in FIG. 2C, the data receiving step 31 is taken as example of the step process being executed by the machine learning model. The operation interface 21 shows the Interactive question-and-answer area 212 through a conversation window and near the machine learning model training 34, and the Interactive question-and-answer area 212 can include a query input part 2121 and a question and answer display part 2122. It should be noted that, the embedded Interactive question-and-answer area 212 cab be presented at any appropriate location in the operation 211, or presented via a popup; however, these examples are merely for exemplary illustration, and the application field of the present invention is not limited to these examples.

Please refer to FIGS. 2B and 2D, which are schematic views of a query message of system of assisting in building machine learning model without programming, according to the present invention.

The query input part 2121 provides an operator to input a query message related to the data receiving step 31 which is the step process being executed by the machine learning model. After the operator input the query message “question A” into the query input part 2121, the query message “the question A” is displayed on the question and answer display part 2122, that is, the question and answer display part 2122 is used to display the query message.

Next, the query message “question A” is transmitted to the artificial intelligence platform 10 through an application programming interface, and the artificial intelligence platform 10 provides the query message “question A” to the large language model. After the answer message “answer A” is generated, the answer message “answer A” is transmitted to the machine learning model building host 20 through the application programming interface.

In actual implementation, the artificial intelligence platform 10 can use a chatbot of the large language model, and the large language model can be a generative pre-trained transformer (GPT) model, PaLM, Galactica, LLaMA or LaMDA; however, these examples are merely for exemplary illustration, and the application field of the present invention is not limited to these examples.

The machine learning model building host 20 displays the answer message “answer A” on the question and answer display part 2122, as shown in FIG. 2E, which is a schematic view of an answer message of a system of assisting in building machine learning model without programming, according to the present invention.

In addition, the machine learning model building host 20 can pre-built the host language model which is not shown in figures herein. The host language model is a language model, and the host language model performs word parsing on the answer message. The answer message is provided to the host language model to perform a word parsing process, to parse at least one label suggestion content or at least one feature word. It should be noted that the label suggestion content can be a words, sentence or segment, but these examples are merely for exemplary illustration, and the application field of the present invention is not limited to these examples.

The host language model is built through the step processes of the machine learning model, the machine learning model used by the host language model can be built by, for example, supervised labeling, unsupervised labeling, semi-supervised labeling, or reinforcement learning. In an embodiment, the host language model can use existing GPT, BERT, PaLM, Galactica, LLaMA, LaMDA, but these examples are merely for exemplary illustration, and the application field of the present invention is not limited to these examples.

In a condition that the host language model using one of supervised learning model and semi-learning supervised model needs to label all data or at least one part of data, for example, the manner of labeling the data can be process feedback, human labeling, or weak supervision, but these examples are merely for exemplary illustration, and the application field of the present invention is not limited thereto. The trained host language model can be used to parse at least one label suggestion content or at least one feature word from the answer message.

Particularly, the host language model parses the sentence or words between the bullets (such as ▪, ●, ♦, ⊚, \textcircled{4}, (2), II, vi, or α) and specific punctuation marks (such as colon “:”, comma “,”, period “.”), as a label suggestion content or a feature word. For example, when the answer message is “⊚step A:”, the host language model parses the sentence “step A” between the bullet “⊚” to the specific punctuation mark “:” as a feature word. The host language model can parse the sentence or words after the bullets of the answer message as the label suggestion content or the feature word, for example, when the answer message is “αdescription content”, the host language model parses the sentence “description content” after the bullets “α” as the label suggestion content; however, these examples are merely for exemplary illustration, and the application field of the present invention is not limited thereto.

In addition, the host language model first splits the answer message into sentences or segments, and performs data processing (such as uppercase to lowercase conversion, full-width to half-width conversion) on the split sentences or segments, and finds abbreviated words, words labelled in different languages, comparison of keywords or sentences, indented paragraph after specific punctuation marks (for example: colon “:”, comma “,”, period “.”, etc.), so as to parse the label suggestion content or the feature word; however, these examples are merely for exemplary illustration, and the application field of the present invention is not limited thereto.

Particularly, when the answer message is “⊚step A:the content of the step A. (the content has been indented)”, the host language model splits the “⊚step A:the content of the step A” into segments, the host language model parses “the content of the step A” as the label suggestion content. When the answer message is “machine learning model uses existing GPT”, the host language model splits the “machine learning model uses existing GPT” into multiple sentences based on the abbreviated word “GPT” and the key word “machine learning model”, so that the host language model parses “GPT” and “machine learning model” as feature words; however, these examples are merely for exemplary illustration, and the application field of the present invention is not limited to these examples.

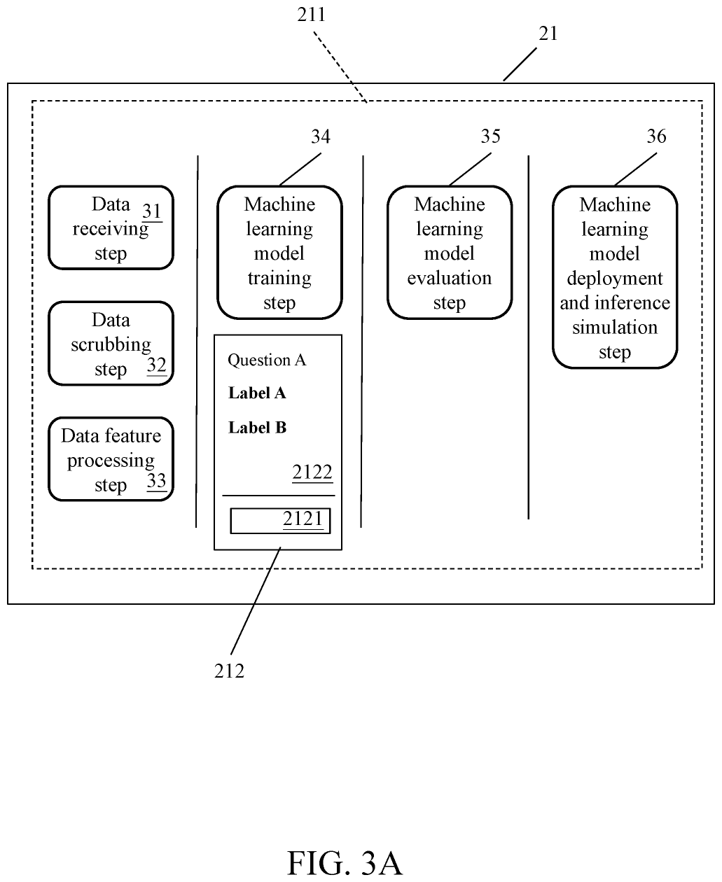

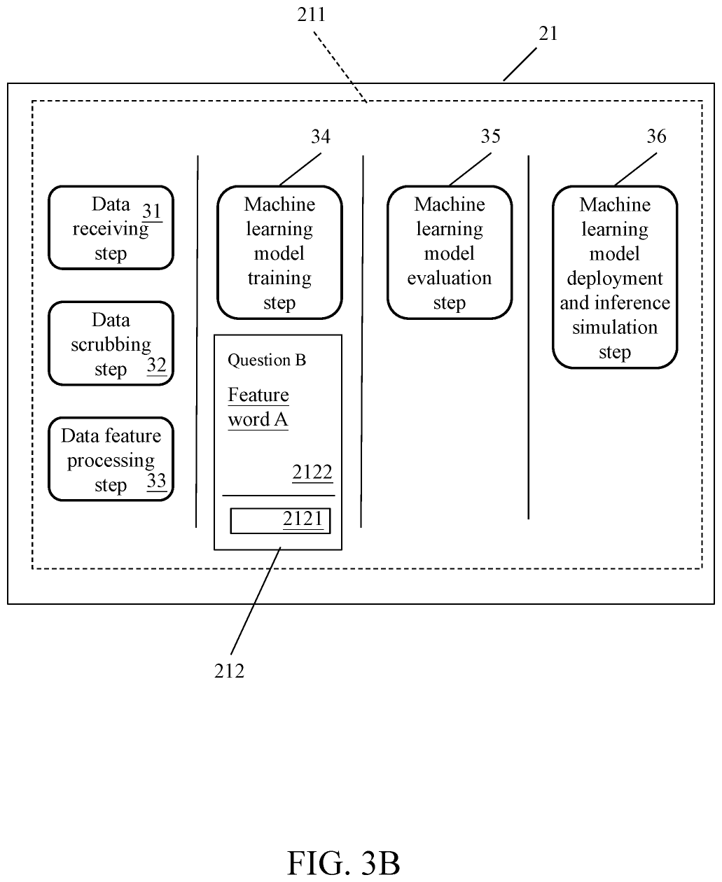

Please refer to FIG. 3A, which is a schematic view of label suggestion of a system of assisting in building machine learning model without programming, according to the present invention.

After the host language model parses the answer message, the parsed label suggestion content 41 includes “label A” and “label B”, when the answer message is displayed on the question and answer display part 2122, the “label A” and “label B” of the label suggestion content parsed from the answer message are highlighted, for example, in FIG. 3, the “label A” and “label B” are shown with emphasis, but these examples are merely for exemplary illustration, and the application field of the present invention is not limited to these examples.

Please refer to FIG. 3B, which is a schematic view of a feature word of a system of assisting in building machine learning model without programming, according to the present invention.

After the host language model parses the answer message, the parsed feature word 42 is “feature word A”, a hyperlink is built between the feature word 42 “feature word A” parsed from the answer message and the operation component 32 of the step process being executed displayed on the machine learning model building operation area 211. When the answer message is displayed on the question and answer display part 2122, the feature word 42 “feature word A” parsed from the answer message is displayed in form of hyperlink, and when the feature word 42 “feature word A” is clicked, the operation of the operation component 32 corresponding to the step process is executed.

It is to be particularly noted that, in actual implementation, the present invention can be implemented fully or partly based on hardware, for example, one or more component of the system can be implemented by integrated circuit chip, system on chip (SOC), a complex programmable logic device (CPLD), or a field programmable gate array (FPGA). The non-transitory computer readable storage medium of the present invention records computer readable program instructions, and the processor can execute the computer readable program instructions (or call computer program instructions) to implement concepts of the present invention. The computer readable storage medium can be a tangible apparatus for holding and storing the instructions executable of an instruction executing apparatus. The non-transitory computer readable storage medium can be, but not limited to electronic storage apparatus, magnetic storage apparatus, optical storage apparatus, electromagnetic storage apparatus, semiconductor storage apparatus, or any appropriate combination thereof. More particularly, the computer readable storage medium can include a hard disk, an RAM memory, a read-only-memory, a flash memory, an optical disk, a floppy disc or any appropriate combination thereof, but this exemplary list is not an exhaustive list. The non-transitory computer readable storage medium is not interpreted as the instantaneous signal such a radio wave or other freely propagating electromagnetic wave, or electromagnetic wave propagated through waveguide, or other transmission medium (such as optical signal transmitted through fiber cable), or electric signal transmitted through electric wire. Furthermore, the computer readable program instruction can be downloaded from the non-transitory computer readable storage medium to each calculating/processing apparatus, or downloaded through network, such as internet network, local area network, wide area network and/or wireless network, to external computer equipment or external storage apparatus. The network includes copper transmission cable, fiber transmission, wireless transmission, router, firewall, switch, hub and/or gateway. The network card or network interface of each calculating/processing apparatus can receive the computer readable program instructions from network, and forward the computer readable program instruction to store in non-transitory computer readable storage medium of each calculating/processing apparatus. The computer program instructions for executing the operation of the present invention can include source code or object code programmed by assembly language instructions, instruction-set-structure instructions, machine instructions, machine-related instructions, micro instructions, firmware instructions or any combination of one or more programming language. The programming language include object oriented programming language, such as Common Lisp, Python, C++, Objective-C, Smalltalk, Delphi, Java, Swift, C#, Perl, Ruby, and PHP, or regular procedural programming language such as C language or similar programming language.

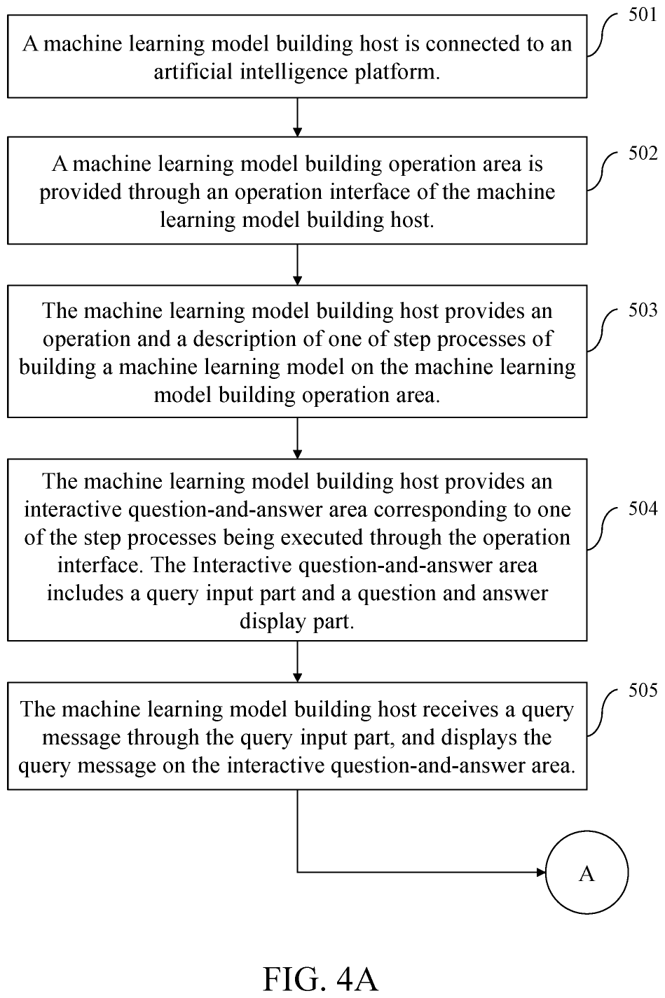

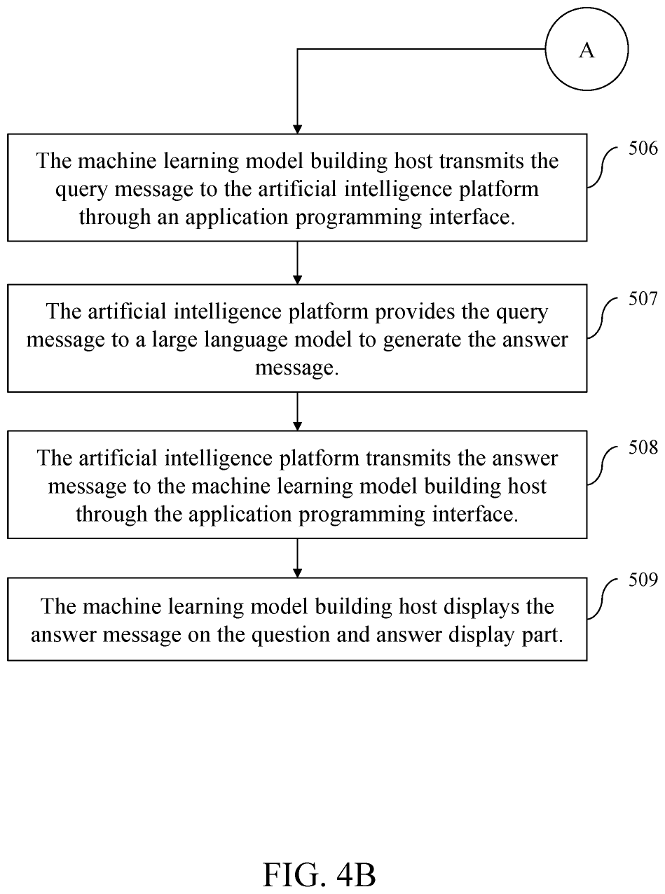

The operation of a method of the present invention will be described in the following paragraphs. Please refer to FIGS. 4A and 4B, which are flowcharts of a method of assisting in building machine learning model without programming, according to the present invention.

As shown in FIGS. 4A and 4B, the method of assisting in building machine learning model without programming includes the following steps.

In a step 501, a machine learning model building host is connected to an artificial intelligence platform. In a step 502, a machine learning model building operation area is provided through an operation interface of the machine learning model building host. In a step 503, the machine learning model building host provides an operation and a description of one of step processes of building a machine learning model on the machine learning model building operation area. In a step 504, the machine learning model building host provides an interactive question-and-answer area corresponding to one of the step processes being executed through the operation interface. The Interactive question-and-answer area includes a query input part and a question and answer display part. In a step 505, the machine learning model building host receives a query message through the query input part, and displays the query message on the interactive question-and-answer area. In a step 506, the machine learning model building host transmits the query message to the artificial intelligence platform through an application programming interface. In a step 507, the artificial intelligence platform provides the query message to a large language model to generate the answer message. In a step 508, the artificial intelligence platform transmits the answer message to the machine learning model building host through the application programming interface. In a step 509, the machine learning model building host displays the answer message on the question and answer display part.

According to the above-mentioned system and method of the present invention, the machine learning model building host provides the interactive question-and-answer area corresponding to the step process being executed through an operation interface; the machine learning model building host provides the query message to the artificial intelligence platform through the interactive question-and-answer area of an application programming interface, and the artificial intelligence platform provides the query message to the large language model to generate an answer message, the artificial intelligence platform transmits the answer message to the machine learning model building host through the application programming interface, so as to achieve the technical effect of assisting in building a machine learning model without programming.

Therefore, the technical solution of the present invention is able to solve the problem of the conventional machine learning model building system with a drag-and-drop GUI interface lacks of assisting in building the machine learning model, to achieve the technical effect of assisting in building a machine learning model without programming.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A system of assisting in building machine learning model without programming, comprising
an artificial intelligence platform, configured to receive a query message through an application programming interface, provide the query message to a large language model to generate an answer message, and transmit the answer message through the application programming interface; and
a machine learning model building host, comprising:
an operation interface, configured to provide a machine learning model building operation area;
a non-transitory computer readable storage medium, configured to store computer readable instructions; and
a hardware processor, electrically connected to the non-transitory computer readable storage medium and the operation interface, and configured to execute the computer readable instructions to make machine learning model building host perform:
providing an operation and a description of each of step processes of building a machine learning model on the machine learning model building operation area;
providing an interactive question-and-answer area corresponding to one of the step processes being executed, through an operation interface, wherein the Interactive question-and-answer area comprises a query input part and a question and answer display part;
receiving the query message on the query input part, transmitting the query message through an application programming interface, and displaying the query message on the question and answer display part; and
receiving the answer message through the application programming interface, and displaying the answer message on the question and answer display part.

2. The system of assisting in building machine learning model without programming according to claim 1, wherein the machine learning model building host performs:
pre-building a host language model; and
providing the answer message to the host language model to perform a word parsing, to parse at least one label suggestion content or at least one feature word.

3. The system of assisting in building machine learning model without programming according to claim 2, wherein the machine learning model building host performs:
when the answer message is displayed on the question and answer display part, highlighting the at least one label suggestion content parsed from the answer message.

4. The system of assisting in building machine learning model without programming according to claim 2, wherein the machine learning model building host performs:
building a hyperlink between the at least one feature word parsed from the answer message to an operation component displayed on the machine learning model building operation area and corresponding to the step process being executed;
when the answer message is displayed on the question and answer display part, displaying the at least one feature word parsed from the answer message, through the hyperlink; and
when one of the at least one feature word is clicked, executing the one of the step processes corresponding to the operation component.

5. The system of assisting in building machine learning model without programming according to claim 1, wherein the step processes of the machine learning model comprise a data receiving step, a data scrubbing step, a data feature processing step, a machine learning model training step, and a machine learning model evaluation step, and a machine learning model deployment and inference simulation step.

6. A method of assisting in building machine learning model without programming, comprising:
connecting a machine learning model building host and an artificial intelligence platform;
providing a machine learning model building operation area through an operation interface of the machine learning model building host;
providing an operation and a description of one of step processes of building a machine learning model on the machine learning model building operation area, by the machine learning model building host;
providing an interactive question-and-answer area corresponding to one of the step processes being executed through the operation interface, by the machine learning model building host, wherein the Interactive question-and-answer area comprises a query input part and a question and answer display part;
receiving a query message through the query input part of the machine learning model building host, and displaying the query message on the interactive question-and-answer area;
transmitting the query message to the artificial intelligence platform through an application programming interface of the machine learning model building host;
providing the query message to a large language model to generate the answer message, by the artificial intelligence platform;
transmitting the answer message to the machine learning model building host through the application programming interface, by the artificial intelligence platform; and
displaying the answer message on the question and answer display part, by the machine learning model building host.

7. The method of assisting in building machine learning model without programming according to claim 6, further comprising:
pre-building a host language model, and providing the answer message to the host language model to perform a word parsing, to parse at least one label suggestion content or at least one feature word, by the machine learning model building host.

8. The method of assisting in building machine learning model without programming according to claim 7, further comprising:
when the answer message is displayed on the question and answer display part, highlighting the at least one label suggestion content parsed from the answer message, by the machine learning model building host.

9. The method of assisting in building machine learning model without programming according to claim 7, further comprising:
building a hyperlink between the at least one feature word parsed from the answer message to an operation component displayed on the machine learning model building operation area and corresponding to the step process being executed, by the machine learning model building host;
when the answer message is displayed on the question and answer display part, displaying the at least one feature word parsed from the answer message in a form of the hyperlink, by the machine learning model building host; and
when one of the at least one feature word is clicked, executing the one of the step processes corresponding to the operation component, by the machine learning model building host.

10. The method of assisting in building machine learning model without programming according to claim 6, wherein the step processes of the machine learning model comprise a data receiving step, a data scrubbing step, a data feature processing step, a machine learning model training step, and a machine learning model evaluation step, and a machine learning model deployment and inference simulation step.
